(19) United States
(12) Patent Application Publication
(10) Pub. No.: US 2021/0327283 A1
(43) Pub. Date: Oct. 21, 2021

(54) Systems and Methods for Mobile Aerial Flight Planning and Image Capturing Based on Structure Footprints

(71) Applicant: Insurance Services Office, Inc., Jersey City, NJ (US)

(72) Inventors: Corey David Reed, Cedar Hills, UT (US); Troy Tomkinson, Saratoga Springs, UT (US)

(73) Assignee: Insurance Services Office, Inc., Jersey City, NJ (US)

(21) Appl. No.: 17/234,097

(22) Filed: Apr. 19, 2021

Related U.S. Application Data
(60) Provisional application No. 63/011,709, filed on Apr. 17, 2020.

(51) Int. Cl. G08G 5/00; G08G 5/04; B64C 39/02; B64D 47/08; G06K 9/00

(52) U.S. Cl. CPC G08G 5/003; G08G 5/0069; G08G 5/0086; B64C 2201/127; B64C 39/024; B64D 47/08; G06K 9/00637; G08G 5/045

(57) ABSTRACT

A system and method for flight planning for an unmanned aircraft. The system generates an aerial imagery map of a capture area and determines a footprint of a structure present in the capture area by marking the structure. The system determines a difference between a takeoff elevation of the unmanned aircraft and a predetermined elevation above a center of the structure and calibrates the difference between the takeoff elevation of the unmanned aircraft and the predetermined elevation above the center of the structure. The system determines, based on the calibration, a flight path elevation of the unmanned aircraft to capture images of the structure. The system generates a flight plan based on criteria for capturing the images of the structure and executes the flight plan.

### RELATED APPLICATIONS

This application claims priority to U.S, Provisional Patent Application Ser. No. 63/011,709 filed on Apr. 17, 2020, the entire disclosure of which is hereby expressly incorporated by reference

### BACKGROUND

### Technical Field

The present disclosure relates generally to the field of unmanned aircraft technology. More specifically, the present disclosure relates to systems and methods for mobile aerial flight planning and image capturing based on structure footprints.

### Related Art

In the unmanned aircraft field, increasingly sophisticated software-based systems are being developed for flight planning and flight automation. Such systems have wide applicability, including but not limited to, navigation, videography and other fields of endeavor. In the field of aerial image processing, there is interest in the application of unmanned aircraft systems for automatically generating and executing a flight plan to capture required images to create a precise and comprehensive model of one or more desired features present in the images (e.g., generating models of buildings, other structures, portions and/or attributes of buildings/structures, property features, etc.). In particular, there is interest in developing a mobile application that can generate and execute a flight plan for calibrating and capturing images of structures and the roofs thereof based on respective footprints of the structures with minimal user involvement. Current mobile applications for unmanned aircraft have limited capabilities including the inability to mark a structure and generate a flight plan based on the marked structure, identify flight path obstacles, determine an initial height of a structure, execute calibration to determine a highest point of a structure and determine multiple image waypoints based on calibration results.

As such, it would be highly beneficial to develop system and methods that can generate a flight plan based on a marked structure and automatically detect and avoid obstacles present in a flight path for capturing images of structures and the roofs thereof, requiring no (or, minimal) user involvement, and with a high degree of accuracy. Still further, there is a need for systems and methods which can automatically generate and execute flight plans (for capturing images) which do not include any obstacles in the flight path. Accordingly, the systems and methods of the present disclosure addresses these and other needs.

### SUMMARY

The present disclosure relates to systems and methods for mission planning and flight automation for unmanned aircraft. In particular, the present disclosure relates to systems and methods for mobile aerial flight planning and image capturing based on structure footprints. The system includes at least one hardware processor coupled to an aerial imagery database. The hardware processor can execute flight planning system code (i.e., non-transitory computer- readable instructions) that is configured to generate and execute a flight plan, requiring no (or, minimal) user involvement. In particular, the hardware processor can execute the flight planning system code to generate and execute flight planning and image capturing based on the structure footprint.

### BRIEF DESCRIPTION OF THE DRAWINGS

The foregoing features of the present disclosure will be apparent from the following Detailed Description of the Invention, taken in connection with the accompanying drawings, in which:

FIG. 1 is a diagram illustrating hardware and software components capable of being utilized to implement the system of the present disclosure;

FIG. 2 is a flowchart illustrating processing steps carried out by the system of the present disclosure;

FIG. 3 is a flowchart illustrating step 102 of FIG. 2 in greater detail;

FIG. 4 is a flowchart illustrating step 104 of FIG. 2 in greater detail;

FIG. 5 is a diagram illustrating the processing steps of FIG. 4;

FIG. 6 is a flowchart illustrating step 106 of FIG. 2 in greater detail;

FIG. 7 is a diagram illustrating the processing steps of FIG. 6;

FIG. 8 is a flowchart illustrating step 108 of FIG. 2 in greater detail;

FIG. 9 is a flowchart illustrating step 220 of FIG. 8 in greater detail;

FIG. 10 is a diagram illustrating the processing steps of FIG. 9;

FIG. 11 is a flowchart illustrating step 222 of FIG. 8 in greater detail;

FIG. 12 is a diagram illustrating the processing steps of FIG. 11;

FIG. 13 is a diagram illustrating image overlap based on images captured during a flight plan generated by the system of the present disclosure;

FIG. 14 is a flowchart illustrating step 224 of FIG. 8 in greater detail;

FIG. 15 is a diagram illustrating an aspect of the processing steps of FIG. 14;

FIG. 16 is a diagram illustrating another aspect of the processing steps of FIG. 14;

FIG. 17 is a flowchart illustrating step 110 of FIG. 2 in greater detail; and

FIG. 18 is a diagram illustrating the processing steps of FIG. 17.

### DETAILED DESCRIPTION

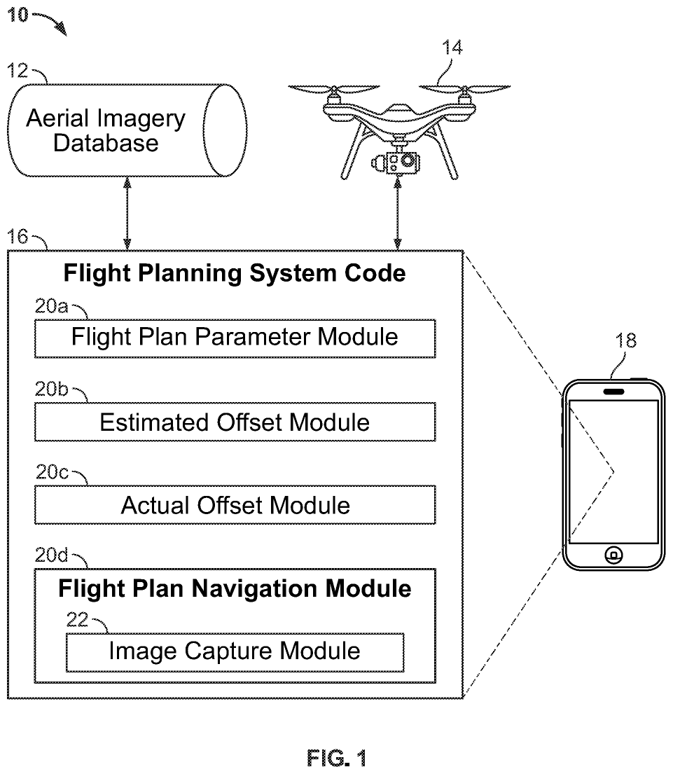

The present disclosure relates to a system and method for mobile aerial flight planning and image capturing based on a structure footprint, as described in detail below in connection with FIGS. 1-18.

Turning to the drawings, FIG. 1 is a diagram illustrating hardware and software components capable of implementing the system 10 of the present disclosure. The system 10 could be embodied as a central processing unit (e.g. a hardware processor) of a mobile terminal 18 coupled to an aerial imagery database 12. The hardware processor can execute flight planning system code 16 (i.e., non-transitory computer-readable instructions) that is configured to generate and execute a flight plan, requiring no (or, minimal) user involvement. In particular, the hardware processor can execute the flight planning system code 16 to generate and execute flight planning and image capturing based on a structure footprint. The hardware processor could include, but is not limited to, a personal computer, a laptop computer, a tablet computer, a smart telephone, a server, and/or a cloud-based computing platform. Alternatively, the system 10 could be embodied as unmanned aircraft system code (non-transitory, computer-readable instructions) stored on a computer-readable medium and executable by a hardware processor of an unmanned aircraft 14.

The flight planning system code 16 could include various custom-written software modules that carry out the steps/processes discussed herein, and could include, but is not limited to, a flight plan parameter module 20a, an estimated offset module 20b, an actual offset module 20c, and a flight plan navigation module 20d. The flight plan navigation module 20d could further include an image capture module 22. The flight planning system code 16 could be programmed using any suitable programming languages including, but not limited to, C, C++, C#, Java, Python or any other suitable language. Additionally, the flight planning system code 16 could be distributed across multiple computer systems in communication with each other over a communications network, and/or stored and executed on a cloud computing platform and remotely accessed by a computer system in communication with the cloud platform. The flight planning system code 16 could communicate with the aerial imagery database 12, which could be stored on the same computer system as the flight planning system code 16, or on one or more other computer systems in communication with the flight planning system code 16.

Still further, the system 10 could be embodied as a customized hardware component such as a field-programmable gate array (“FPGA”), application-specific integrated circuit (“ASIC”), embedded system, or other customized hardware component without departing from the spirit or scope of the present disclosure. It should be understood that FIG. 1 is only one potential configuration, and the system 10 of the present disclosure can be implemented using a number of different configurations.

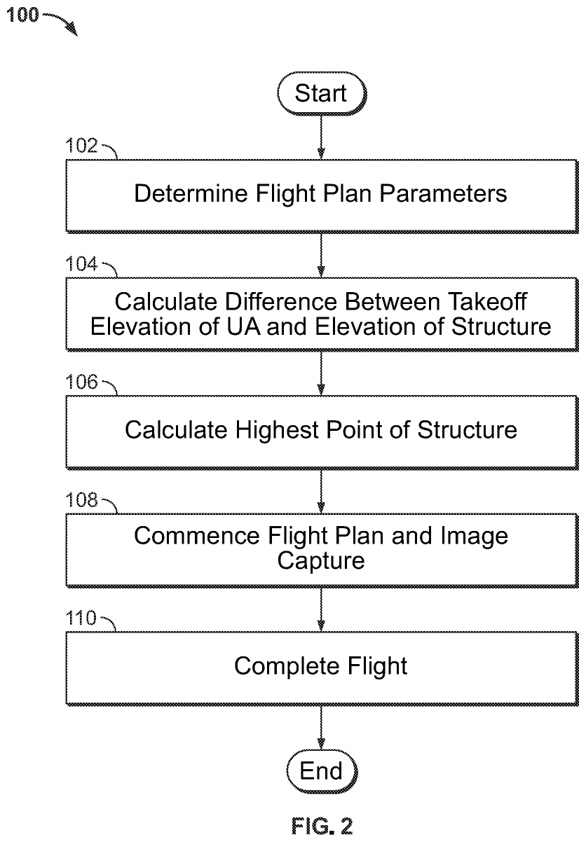

FIG. 2 is a flowchart illustrating processing steps 100 carried out by the hardware processor of the mobile terminal 18 of FIG. 1. The system 10 of the present disclosure allows for the rapid generation, modification and execution of a flight plan to capture required images to create a precise and comprehensive model of a structure present in the images based on a footprint of a structure. The images could include aerial images taken from various angles including, but not limited to, nadir views, oblique views, etc.

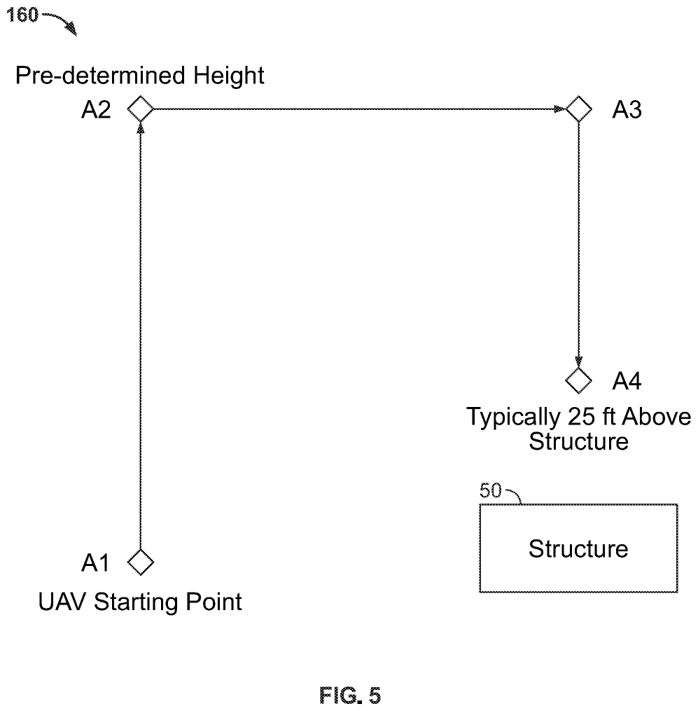

Beginning in step 102, the system 10, in conjunction with a user of a mobile application operating on the mobile terminal 18, can determine flight plan parameters for capturing images of a structure 50 (as shown in FIG. 5) present in a geospatial region of interest (“ROI”). In step 104, the system 10 calculates a difference between a takeoff elevation of the unmanned aircraft 14 and an elevation above a center of the structure 50 through z-probing. Z-probing is a process of determining the height of a structure or other objects within an ROI using the proximity sensors of an unmanned aircraft to measure the distance to the object directly below it. The aircraft descends vertically over the ROI until a measurement can be obtained from the sensor. The aircraft can also fly a pattern across the ROI, recording distance to the objects directly below the aircraft at regular location intervals, to create a height map of the ROI. In step 106, the system 10 calculates a highest point of the structure 50. In step 108, the system 10 commences flying in accordance with the flight plan and image capture along a flight path of the flight plan. Lastly, in step 110, the system 10 completes flying the flight plan.

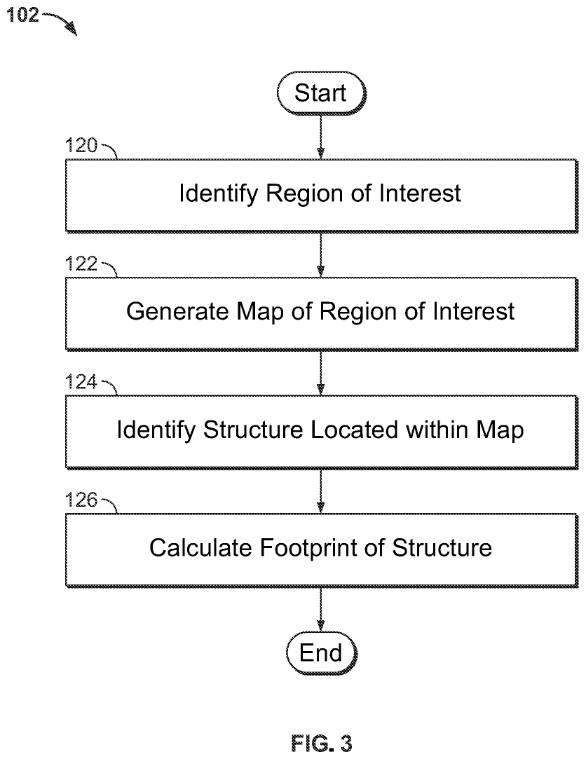

FIG. 3 is a flowchart illustrating step 102 of FIG. 2 in greater detail. In particular, the flowchart illustrates processing steps carried out by the flight plan parameter module 20a of the system 10 for generating a flight plan. Beginning in step 120, a user of the mobile application operating on the mobile terminal 18 can identify a geospatial region of interest (“ROI”). For example, the user of the mobile application can input a geospatial ROI of an area to be captured manually by the mobile terminal 18 or to be captured by the unmanned aircraft 14 during a flight plan created and synchronized with the unmanned aircraft 14. The geospatial ROI can be of interest to the user because of one or more structures 50 present in therein. Those skilled in the art would understand that any type of image captured by any type of image capture source can be used. For example, the images can be ground images captured by image capture sources including, but not limited to, a smartphone, a tablet and a digital camera. The images can also be aerial images captured by image capture sources including, but not limited to, a plane, a helicopter, and the unmanned aircraft 14. In addition, it should be understood that multiple images can overlap all or a portion of the geospatial ROI.

A user can input latitude and longitude coordinates of a geospatial ROI. Alternatively, a user can input an address or a world point of a geospatial ROI. The geospatial ROI can be represented by a generic polygon enclosing a geocoding point indicative of the address or the world point. The geospatial ROI can also be represented as a polygon bounded by latitude and longitude coordinates. In a first example, the bound can be a rectangle or any other shape centered on a postal address. In a second example, the bound can be determined from survey data of property parcel boundaries. In a third example, the bound can be determined from a selection of the user (e.g., in a geospatial mapping interface). Those skilled in the art would understand that other methods can be used to determine the bound of the polygon. The geospatial ROI may be represented in any computer format, such as, for example, well-known text (“WKT”) data, TeX data, HTML data, XML data, etc. For example, a WKT polygon can comprise one or more computed independent world areas based on the detected structure in the parcel.

In step 122, the system 10 generates a map of the geospatial ROI and a property parcel included within the geospatial ROI can be selected based on the geocoding point. Then, in step 124, the system 10 identifies one or more structures 50 situated in the property parcel. For example, a deep learning neural network and/or other computer vision techniques can be applied over the area of the parcel to detect and identify a structure 50 or a plurality of structures 50 situated thereon. In step 126, the system calculates a footprint of the identified structure 50 by marking the identified structure 50. Marking can include outlining the structure 50 and identifying flight path boundaries and obstacles including, but not limited to, other structures (e.g., residential and commercial buildings), flagpoles, water towers, windmills, street lamps, trees, power lines, etc. It is noted that the system 10 can also download an aerial image data package of the geospatial ROI to be captured. The data package could be a pre-existing digital terrain model (DTM), a digital surface model (DSM), a digital elevation model (DEM), and/or any other suitable way of representation elevations above the ground, including, but not limited to, the aforementioned flight path obstacles. Once the structure 50 is marked, integration with the unmanned aircraft 14 provides for flight planning and image capturing based on the calculated footprint of the structure 50.

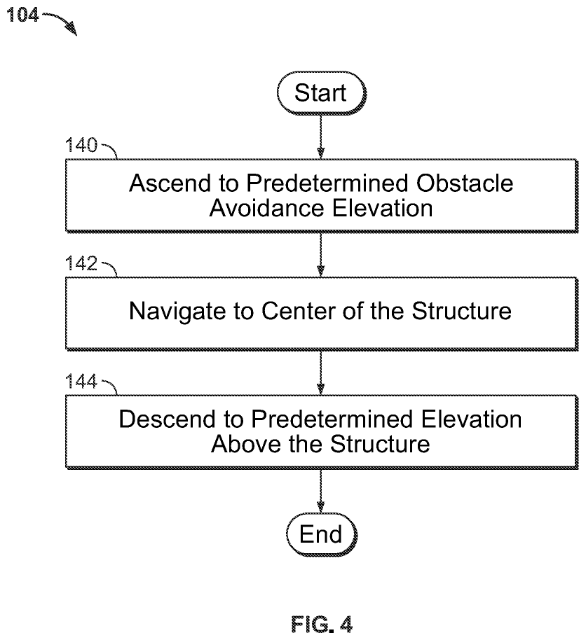

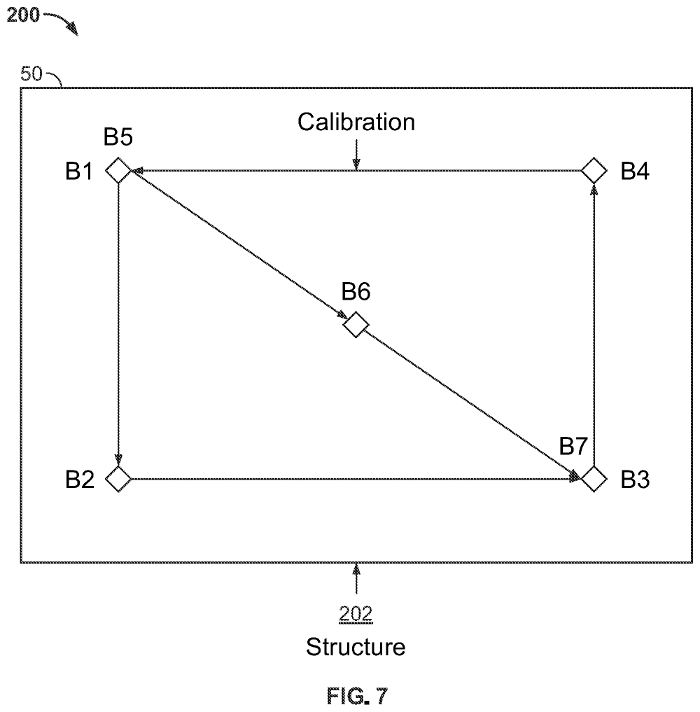

FIG. 4 is a flowchart illustrating step 104 of FIG. 2 in greater detail. In particular, the flowchart illustrates processing steps carried out by the estimated offset module 20b of the system 10 for calculating a difference between a takeoff elevation of the unmanned aircraft 14 and the highest point detected for a given flight path (e.g., an elevation above a center of the structure 50 (see FIGS. 5 and 7)) through z-probing. Z-probing is a process of determining an initial height of the structure 50. Beginning in step 140, the unmanned aircraft 14 ascends from a takeoff latitude and longitude (i.e., a starting point) to a predetermined obstacle avoidance elevation. The starting point can be determined through one or more sensors positioned on an underside of the unmanned aircraft 14. Then, in step 142, the unmanned aircraft 14 navigates to a center of the structure 50 before descending to a predetermined elevation above the structure 50 (e.g., 25 feet from a top of the structure 50) in step 144.

FIG. 5 is a diagram 160 illustrating the processing steps of FIG. 4. As shown in FIG. 5, the unmanned aircraft 14 ascends from a starting point position Al to a predetermined obstacle avoidance elevation position A2. Then, the unmanned aircraft 14 navigates from the predetermined obstacle avoidance elevation position A2 to a position A3 above the structure 50. Lastly, the unmanned aircraft 14 descends from the position A3 to a predetermined elevation position A4 above the structure 50. It is noted that position A4 is typically located 25 feet above the structure 50, but of course, other heights are possible.

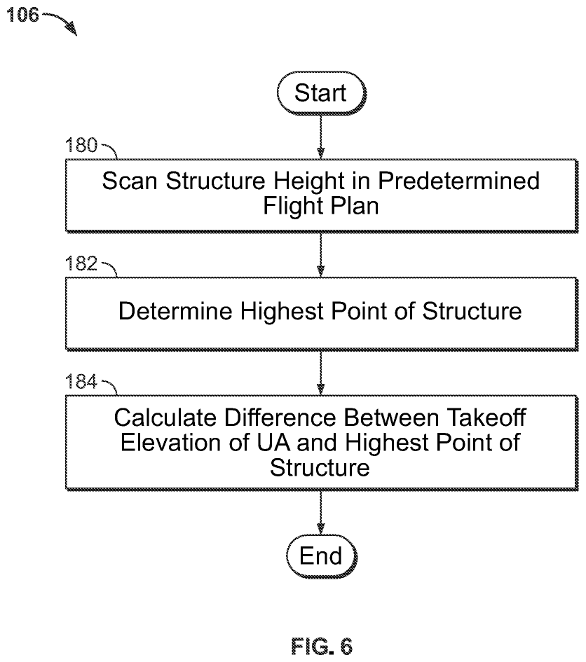

FIG. 6 is a flowchart illustrating step 106 of FIG. 2 in greater detail. In particular, the flowchart illustrates calibration processing steps carried out by the actual offset module 20c of the system 10. Calibration is the process of determining a highest point of the structure 50 and, based on the determination, determining an actual offset between the takeoff elevation of the unmanned aircraft 14 and the highest point of the structure 50. Completion of the calibration process provides for the recalculation of a flight path elevation of the unmanned aircraft 14 and waypoints during flight of the unmanned aircraft 14. As shown in FIG. 6, in step 180 the unmanned aircraft 14 scans a height of the structure 50 by navigating a top of the structure 50 during a flight path of a predetermined flight plan. The predetermined flight plan can include a plurality of waypoints or positions. Then, in step 182, the system 10 determines the highest point of the structure 50 based on the data collected by the unmanned aircraft 14 during the predetermined flight plan. Lastly, in step 184, the system 10 calculates the difference between the takeoff elevation of the unmanned aircraft 14 and the determined highest point of the structure 50.

FIG. 7 is a diagram 200 illustrating the processing steps of FIG. 6. In particular, FIG. 7 illustrates the predetermined calibration flight plan navigated by the unmanned aircraft 14 to determine the highest point of the structure 50 and, based on the determination, determines the actual offset between the takeoff elevation of the unmanned aircraft 14 and the highest point of the structure 50. As shown in FIG. 7, the unmanned aircraft 14 navigates from position B1 to position B5 in a concentric rectangular flight path corresponding to a perimeter 202 of the structure 50. Thereafter, the unmanned aircraft 14 navigates from position B5 to position B7 diagonally across the structure 50 before completing the predetermined flight plan. It is noted that the unmanned aircraft 14 is not limited to the particular flight paths disclosed and discussed herein, which are illustrative in nature. Indeed, the system 10 could plan and automatically execute flight plans having flight paths of other configurations, shapes, paths, etc. For example, the system 10 could automatically plan and execute flight plans having flight paths that are arcuate in shape (e.g., orthodromic arcs) or have other geometries (e.g., radial paths, straight flight paths, etc.).

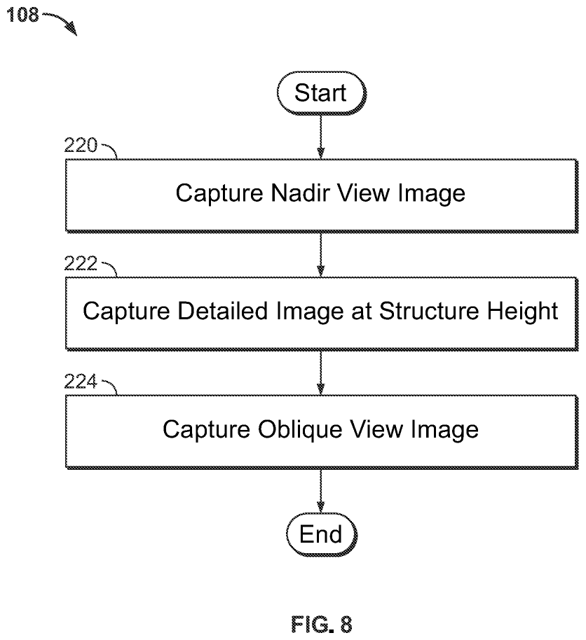

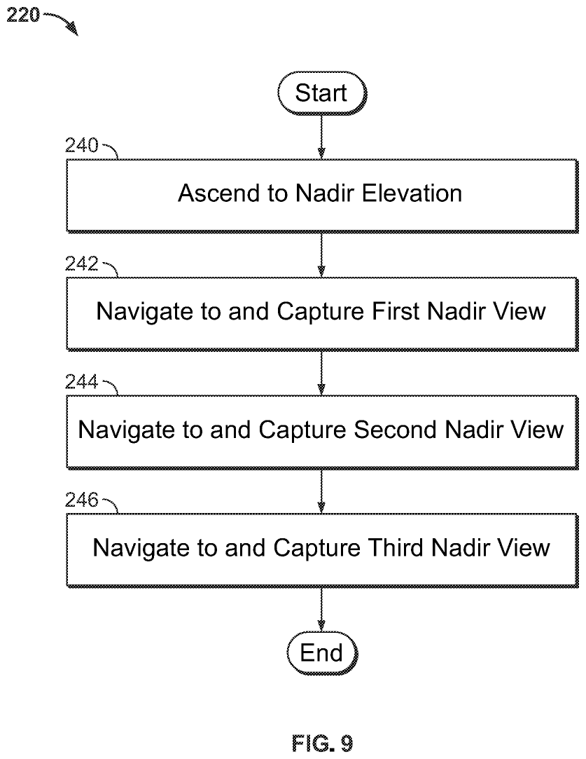

FIG. 8 is a flowchart illustrating step 108 of FIG. 2 in greater detail. In particular, the flowchart illustrates the image capture processing steps carried out by the image capture module 22 of the flight plan navigation module 20d during flight of the unmanned aircraft 14. As shown in FIG. 8, the unmanned aircraft 14 captures nadir view images of a structure 50 in step 220, captures detailed images of a top of the structure 50 in step 222, and captures oblique view images of the structure 50 in step 224. These processing steps will be discussed in greater detail below in connection with FIGS. 9-17. It is noted that the flight plan navigation module 20d calculates and weighs a plurality of factors including, but not limited to, a field of view (“FOV”) of a camera attached to the unmanned aircraft 14, a pre-set aspect ratio of the camera, a pre- programmed overlap of images and a geospatial ROI when generating and executing a flight plan of the unmanned aircraft 14. These factors contribute to the accuracy and consistency of the captured images in steps 220-224.

A camera attached to the unmanned aircraft 14 has a default FOV which can be adjusted via a zoom function. As such, the FOV can be utilized in calculating one or more of a flight path elevation of the unmanned aircraft 14, a distance of the unmanned aircraft 14 from the structure 50 and a number of images of the structure 50 to be captured. For example, the narrower the FOV of the camera attached to the unmanned aircraft 14, the higher the elevation required for a nadir view image to be captured. If a nadir view image is captured from an elevation that is inadequate (e.g. too low), a part or parts of the structure 50 may be omitted from the captured image. In addition, the narrower the FOV of the camera attached to the unmanned aircraft 14, the greater the number of oblique view images that are required to provide complete coverage of the structure 50. The FOV of the camera attached to the unmanned aircraft 14 can be calculated based on a height and a footprint of the structure 50 to be captured.

Similarly, the pre-set aspect ratio of the camera of the unmanned aircraft 14, the pre- programmed overlap of images, and the geospatial ROI (e.g., a size of the structure 50 present in the ROI) can also affect the flight path elevation of the unmanned aircraft 14, the distance of the unmanned aircraft 14 from the structure 50, and the number of images of the structure 50 to be captured. For example, the flight plan navigation module 20d can calculate a number of images necessary to provide contiguous overlapping images as the unmanned aircraft 14 moves along the flight path from the nadir portion of the flight path to the oblique portion of the flight path. By the term “contiguous” images, it is meant two or more images of the structure 50 that are taken at viewing angles such that one or more features of the structure 50 are viewable in the two or more images. Contiguous overlapping images allow for the generation of a model of the structure 50 and viewing options thereof. However, it is noted that the system 10 need not capture contiguous overlapping images of a structure 50 to generate a model of the structure 50, and instead, could generate a model of the structure 50 using a specified number of images taken from one or more predetermined viewing angles.

In another example, the size of the structure 50 present in the ROI can affect the flight path elevation of the unmanned aircraft 14 and the number of images of the structure 50 to be captured. In particular, the taller and larger a structure 50 to be captured is, the higher the elevation a nadir view image needs to be captured from to capture the entire structure 50. Additionally, the taller and larger a structure 50 to be captured is, the greater the number of oblique view images that are required to provide complete coverage of the structure 50.

FIG. 9 is a flowchart illustrating step 220 of FIG. 8 in greater detail. As shown in FIG. 9, the unmanned aircraft 14 ascends to a predetermined elevation and captures three nadir view images. In particular, in step 240, the unmanned aircraft 14 ascends to the predetermined elevation based on the aforementioned factors including, but not limited to, the FOV of the camera attached to the unmanned aircraft 14, the pre-set aspect ratio of the camera, and the geospatial ROI. Then, in step 242 the unmanned aircraft 14 navigates to and captures a first nadir view image. In step 244, the unmanned aircraft 14 navigates to and captures a second nadir view image before navigating to and capturing a third nadir view image in step 246.

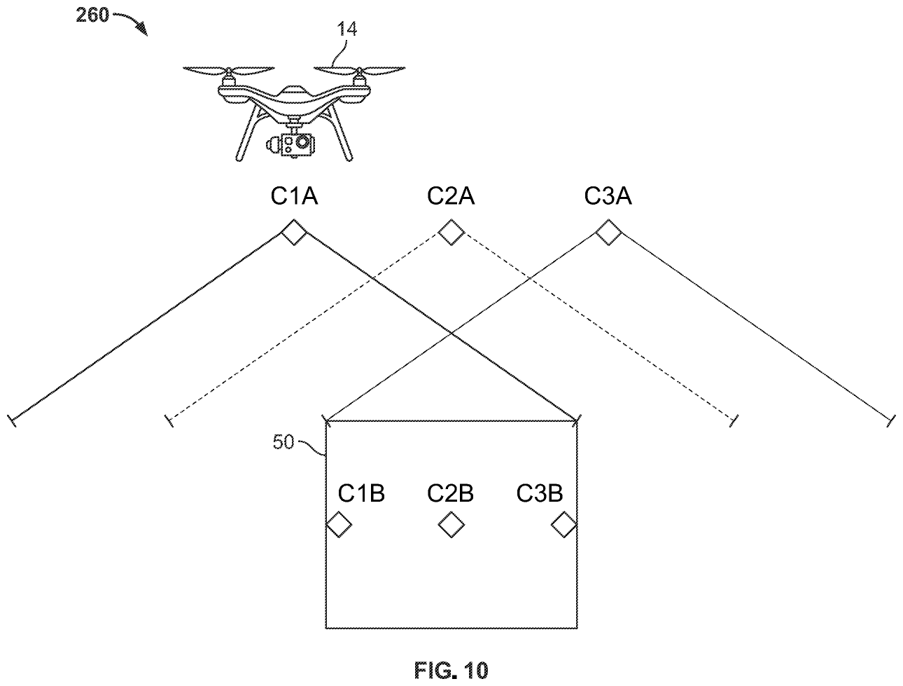

FIG. 10 is a diagram 260 illustrating the processing steps of FIG. 9. As shown in FIG. 10, the unmanned aircraft 14 navigates to each of nadir view image capture waypoints C1A, C2A and C3A. The nadir view image capture waypoints C1A, C2A and C3A respectively correspond to a first edge C1B of the structure 50, a middle C2B of the structure 50 and a second edge C3B of the structure 50.

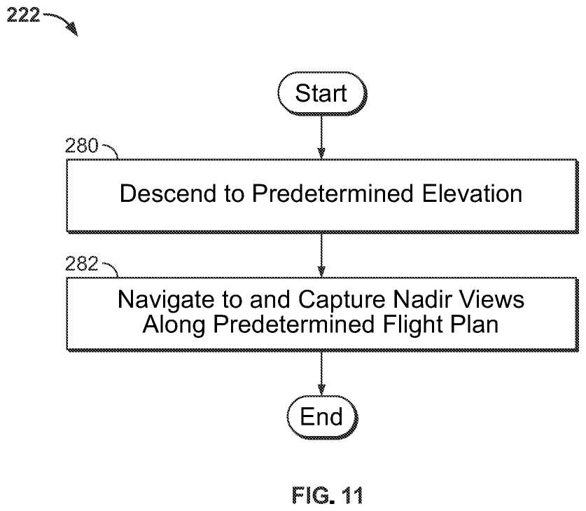

FIG. 11 is a flowchart illustrating step 222 of FIG. 8 in greater detail. In step 280 the unmanned aircraft 14 descends to a predetermined flight path elevation based on factors including, but not limited to, the FOV of the camera attached to the unmanned aircraft 14, the pre-set aspect ratio of the camera, the pre-programmed overlap of images and the geospatial ROI. Then, in step 282, the unmanned aircraft 14 captures nadir view images along a predetermined flight path. It is noted that the nadir view images captured in step 282 of FIG. 11 differ from those captured in steps 242-246 of FIG. 9. For example, the nadir view images captured in step 282 are captured from a closer distance to the structure 50 and ensure that an entirety of a top of the structure is included through several overlapping images.

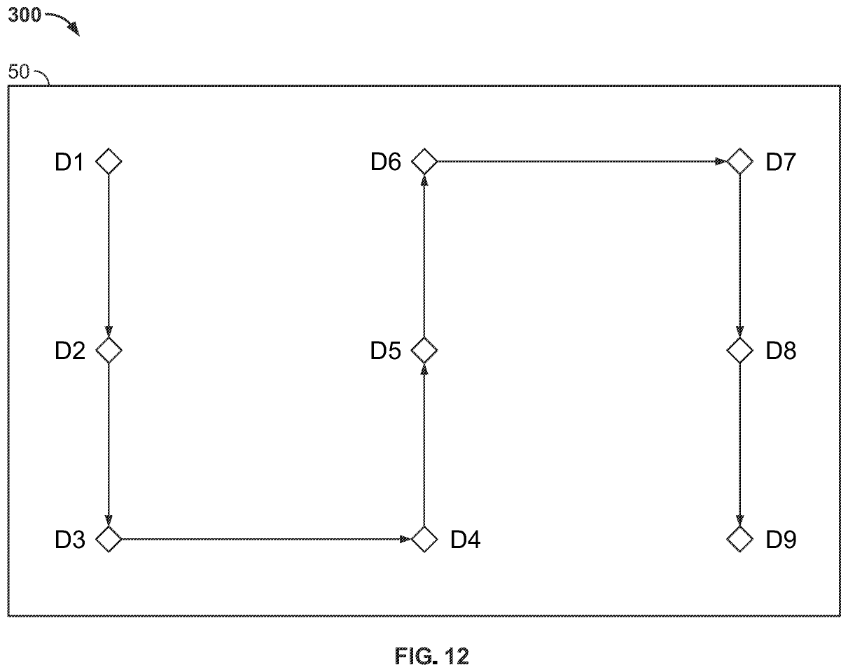

FIG. 12 is a diagram 300 illustrating the processing steps of FIG. 11. As shown in FIG. 12, the unmanned aircraft 14 navigates to each of nadir view image capture waypoints D1-D9. The nadir view image capture waypoints D1-D9 respectively correspond to different portions of the top of the structure 50. As discussed above, it is noted that the unmanned aircraft 14 is not limited to the particular flight paths disclosed and discussed herein, which are illustrative in nature. Indeed, the system 10 could plan and automatically execute flight plans having flight paths of other configurations, shapes, paths, etc. For example, the system 10 could automatically plan and execute flight plans having flight paths that are arcuate in shape (e.g., orthodromic arcs) or have other geometries (e.g., radial paths, straight flight paths, etc.).

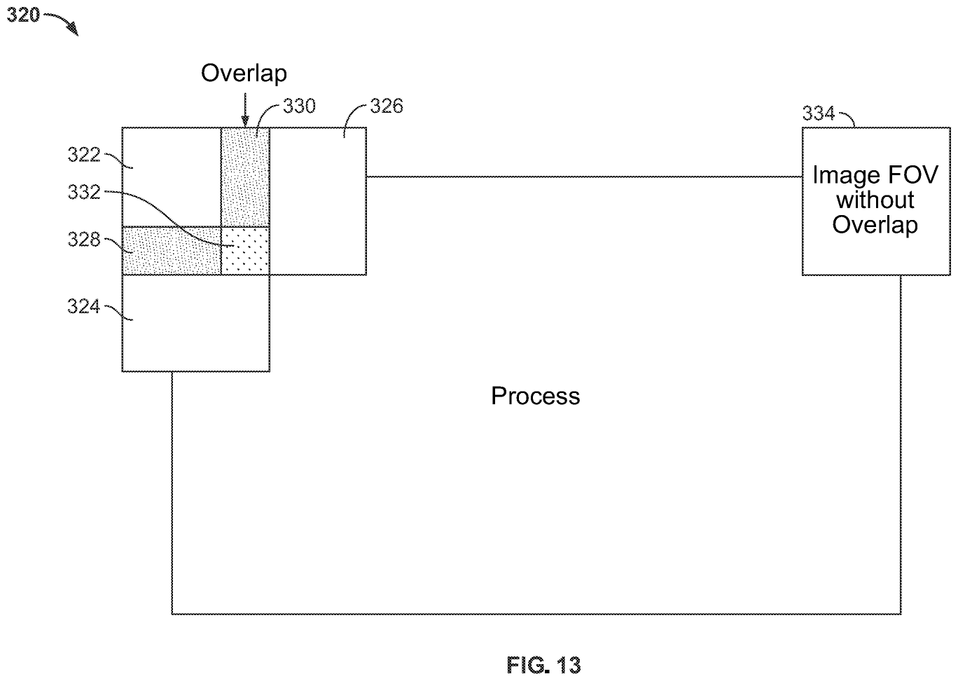

FIG. 13 is a diagram 320 illustrating image overlap during a flight plan generated by the system 10 of the present disclosure. As shown in FIG. 13, images 322, 324 and 326 comprise overlapping images. For example, images 322 and 324 overlap to provide for overlapping image area 328, and images 322 and 326 overlap to provide for overlapping image area 330. Additionally, images 322, 324 and 326 overlap to provide for overlapping image area 332. In contrast, image 334 is indicative of a non-overlapping image.

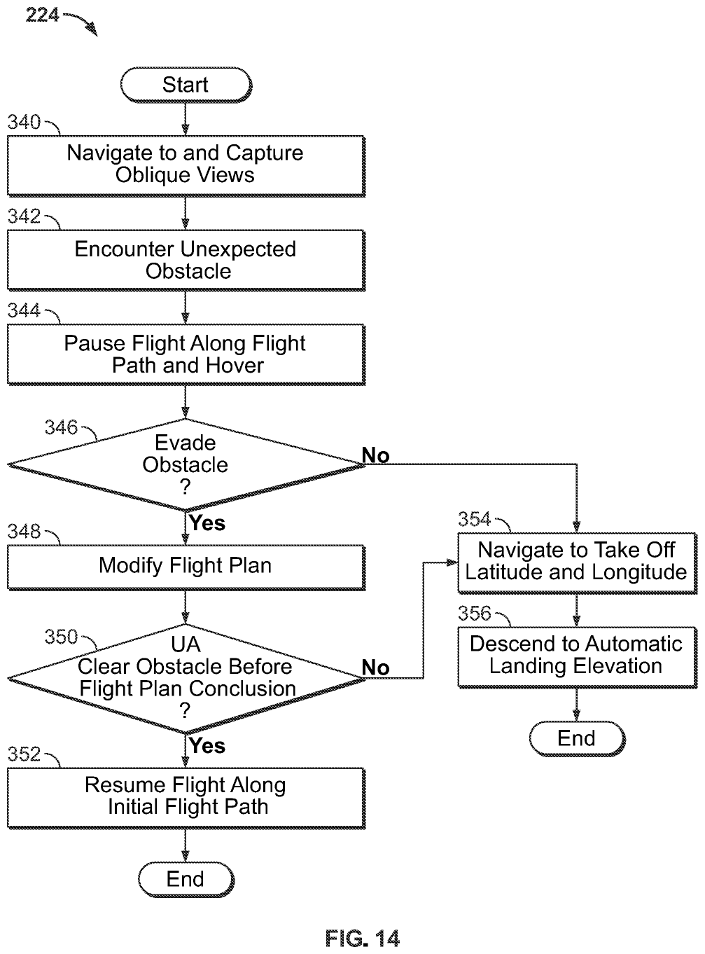

FIG. 14 is a flowchart illustrating step 224 of FIG. 8 in greater detail. In step 340, the unmanned aircraft 14 navigates to oblique view image capture waypoints to capture oblique view images based on factors including, but not limited to, the FOV of the camera attached to the unmanned aircraft 14 and the geospatial ROI. In particular, the unmanned aircraft 14 positions itself at a distance and height from the structure 50 such that the camera attached to the unmanned aircraft 14 is positioned at a forty five degree angle above the structure 50 and angled down onto the structure 50. Additionally, the unmanned aircraft 14 positions itself at a distance from the structure 50 such that the FOV of the camera includes the entirety of the structure 50. The system 10 calculates a number of oblique view images to be captured based on a π/8 calculation. The unmanned aircraft 14 captures the calculated number of oblique view images by navigating to corresponding oblique view capture waypoints in a clockwise direction along a circular flight path around the structure 50.

In step 342, the unmanned aircraft 14 encounters an unexpected obstacle and in step 344, the unmanned aircraft 14 pauses along the flight path and hovers. Then, in step 346, the system 10 determines whether to evade the obstacle based on a calculated direction and distance of the obstacle relative to the unmanned aircraft 14. If the system 10 determines to evade the obstacle, then in step 348 the system 10 modifies the flight plan to avoid the obstacle by modifying the flight path around the obstacle closer to the structure 50. In step 350, the system 10 determines whether the unmanned aircraft 14 has cleared the obstacle before a conclusion of the flight plan. If the system 10 determines that the unmanned aircraft 14 has cleared the obstacle before the conclusion of the flight plan, then in step 352 the unmanned aircraft 14 resumes flight along the initial flight path of the flight plan. If the system 10 determines that the unmanned aircraft 14 has not cleared the obstacle before the conclusion of the flight plan, then in step 354 the unmanned aircraft 14 navigates to a takeoff latitude and longitude before descending to an automatic landing elevation in step 356.

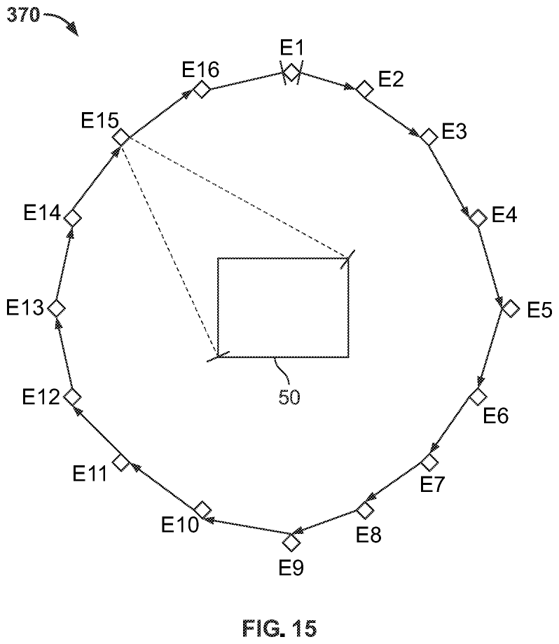

FIG. 15 is a diagram 370 illustrating a flight path of the unmanned aircraft 14 to capture oblique view images of the structure 50. As shown in FIG. 15, the unmanned aircraft 14 navigates to oblique view image capture waypoints E1-E16 in a clockwise direction along a circular flight path around the structure 50 to capture oblique view images thereof. The unmanned aircraft 14 captures the oblique view images based on the calculated FOV of the camera attached to the unmanned aircraft 14 and the geospatial ROI. In particular, the unmanned aircraft 14 positions itself at a distance and height from the structure 50 such that the camera attached to the unmanned aircraft 14 is positioned at a forty five degree angle above the structure 50 and angled down onto the structure 50. Additionally, the unmanned aircraft 14 positions itself at a distance from the structure 50 such that the FOV of the camera includes the entirety of the structure 50.

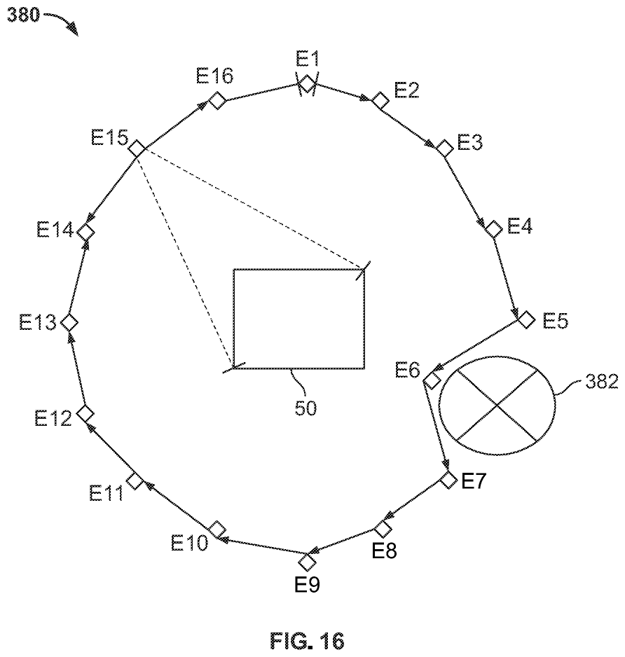

FIG. 16 is a diagram 380 illustrating a flight path of the unmanned aircraft 14 to avoid an obstacle 382 while navigating to oblique view image capture waypoints E1-E16 in a clockwise direction along a circular flight path around the structure 50 to capture oblique view images thereof. As shown in FIG. 16, upon the detection of the obstacle 382 at the oblique view image capture waypoint E5, the system 10 modifies the flight plan to avoid the obstacle 382. In particular, the system 10 modifies the flight path around the obstacle 382 closer to the structure 50 at oblique view image capture waypoint E6. Subsequently, the system 10 determines that the unmanned aircraft 14 has cleared the obstacle 382 before the conclusion of the flight plan and the unmanned aircraft 14 resumes flight along the initial flight path of the flight plan at oblique view image capture waypoint E7.

It is noted that the system 10 of the present disclosure could also include functionality for dynamically navigating around obstacles, in real time as the unmanned aircraft 14 is in flight. For example, the system 10 could classify a nearby obstacle (such as a tree, power line, etc.), and based on the classification, the system 10 could navigate the unmanned aircraft 14 a predefined distance away from the obstacle. Indeed, for example, the system 10 could navigate the unmanned aircraft 14 a pre-defined distance of 20 feet away from an obstacle if the obstacle is classified as a power line, and another distance (e.g., 10 feet) away from an obstacle if the obstacle is classified as a tree. Such a system could implement machine learning techniques, such that the system learns how to classify obstacles over time and as a result, automatically determines what distances should be utilized based on classifications of obstacles. Still further, the system 10 could detect unexpected obstacles (such as birds, other aircraft, etc.) and could navigate the unmanned aircraft 14 away from such obstacles in real time.

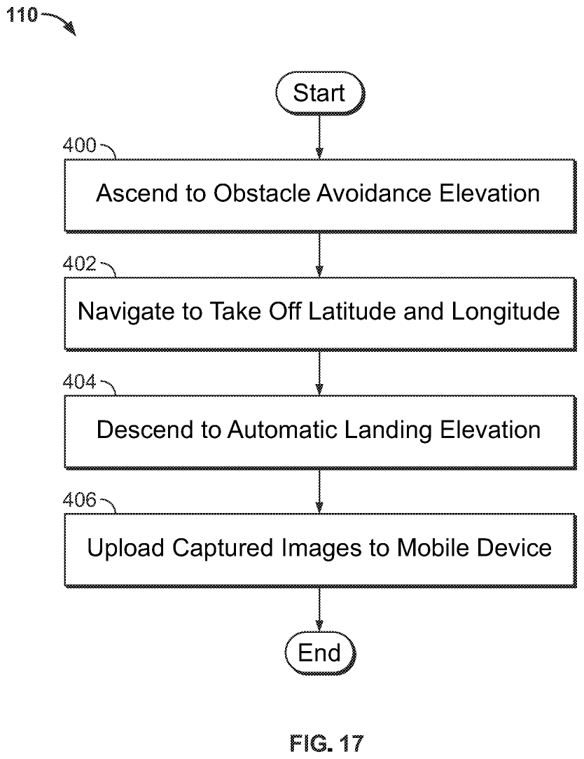

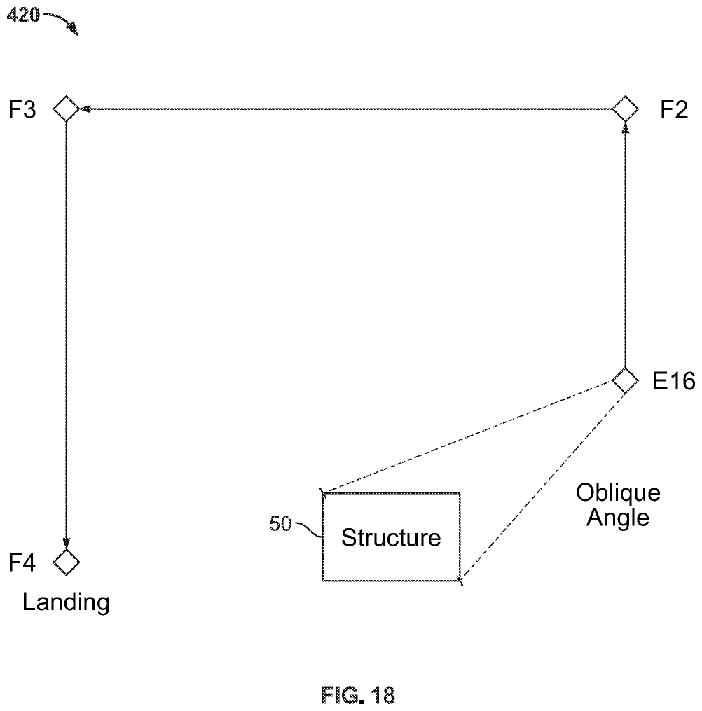

FIG. 17 is a flowchart illustrating step 110 of FIG. 2 in greater detail. Upon completion of image capture, the unmanned aircraft 14 ascends to an obstacle avoidance elevation in step 400. Then, in step 402, the unmanned aircraft 14 navigates to a takeoff latitude and longitude before descending to an automatic landing elevation in step 404. In step 406, the unmanned aircraft 14 can upload the captured images to the mobile terminal 18. FIG. 18 is a diagram 420 illustrating the processing steps of FIG. 17. As shown in FIG. 18, the unmanned aircraft 14 ascends to an obstacle avoidance elevation position F2 from the last oblique view image capture waypoint E16. Then, the unmanned aircraft 14 navigates to a position F3 above a takeoff latitude and longitude indicative of the initial starting position of the flight path before descending to the automatic landing elevation position F4.

Having thus described the present disclosure in detail, it is to be understood that the foregoing description is not intended to limit the spirit or scope thereof.

1. A system for flight planning for an unmanned aircraft, comprising:
an unmanned aircraft; and
a processor in communication with the unmanned aircraft, the processor:
generating an aerial imagery map of a capture area;
determining a footprint of a structure present in the capture area;
determining a difference between a takeoff elevation of the unmanned aircraft and a predetermined elevation above a center of the structure;
calibrating the difference between the takeoff elevation of the unmanned aircraft and the predetermined elevation above the center of the structure;
determining, based on the calibration, a flight path elevation of the unmanned aircraft to capture images of the structure;
generating a flight plan based on criteria for capturing the images of the structure; and
executing the flight plan.

2. The system of claim 1, wherein the processor receives an aerial imagery data package of the capture area from a database, the aerial image data package being a pre-existing digital terrain model, a digital surface model, or a digital elevation model.

3. The system of claim 1, wherein the processor is a personal computer, a laptop computer, a tablet computer, a smart telephone, a server or a cloud-based computing platform.

4. The system of claim 1, wherein the processor determines the difference between the takeoff elevation of the unmanned aircraft and the predetermined elevation above the center of the structure by:
monitoring at least one proximity sensor of the unmanned aircraft; and
controlling, based on the monitoring, the unmanned aircraft to ascend to a predetermined obstacle avoidance elevation, navigate to the center of the structure, and descend to the predetermined elevation above the center of the structure.

5. The system of claim 1, wherein the processor calibrates the difference between the takeoff elevation of the unmanned aircraft and the predetermined elevation above the center of the structure by:
controlling the unmanned aircraft to navigate according to a flight path of a predetermined flight plan for scanning a top of the structure;
determining a highest point of the structure based on data collected by the unmanned aircraft during the predetermined flight plan; and
determining a difference between the takeoff elevation of the unmanned aircraft and the highest point of the structure.

6. The system of claim 1, wherein the generated flight plan is based on one or more of a field of view of a camera attached to the unmanned aircraft, a pre-set aspect ratio of the camera, a height of the structure, or the footprint of the structure.

7. The system of claim 1, wherein the processor controls the unmanned aircraft along a flight path of the generated flight plan to:
ascend to a nadir view elevation;
capture at least one nadir view image of the structure;
capture overlapping images of a top of the structure;
capture at least one oblique view image of the structure;
navigate to a take off latitude and longitude; and
descend to an automatic landing elevation.

8. The system of claim 7, wherein the processor controls the unmanned aircraft to capture at least one nadir view image of the structure by controlling the unmanned aircraft to:
navigate to and capture at first nadir view image of a first edge of the structure;
navigate to and capture a second nadir view image of a middle of the structure; and
navigate to and capture a third nadir view image of a second edge of the structure.

9. The system of claim 7, wherein the processor controls the unmanned aircraft to capture overlapping images of the top of the structure by controlling the unmanned aircraft to:
descend to a predetermined elevation; and
capture the overlapping images of the top of the structure according to a predetermined flight path having a plurality of waypoints, each waypoint of the predetermined flight path corresponding to a different portion of the top of the structure.

10. The system of claim 7, wherein the processor determines an amount of oblique view images of the structure to be captured to provide coverage of the structure; and
controls the unmanned aircraft to capture the determined amount of oblique view images of the structure by navigating the unmanned aircraft to oblique view capture waypoints corresponding to the determined amount of oblique view images.

11. The system of claim 1, wherein the processor determines the unmanned aircraft encounters an unexpected obstacle along a flight path of the generated flight plan; and
controls the unmanned aircraft to evade the unexpected obstacle by modifying the generated flight plan and executing the modified flight plan.

12. A method for flight planning for an unmanned aircraft comprising the steps of:
generating an aerial imagery map of a capture area;
determining a footprint of a structure present in the capture area;
determining a difference between a takeoff elevation of the unmanned aircraft and a predetermined elevation above a center of the structure;
calibrating the difference between the takeoff elevation of the unmanned aircraft and the predetermined elevation above the center of the structure;
determining, based on the calibration, a flight path elevation of the unmanned aircraft to capture images of the structure;
generating a flight plan based on criteria for capturing the images of the structure; and
executing the flight plan.

13. The method of claim 12, further comprising the step of receiving an aerial imagery data package of the capture area from a database, the aerial image data package being a pre-existing digital terrain model, a digital surface model, or a digital elevation model.

14. The method of claim 12, wherein determining the difference between the takeoff elevation of the unmanned aircraft and the predetermined elevation above the center of the structure comprises the steps of:
monitoring at least one proximity sensor of the unmanned aircraft; and
controlling, based on the monitoring, the unmanned aircraft to ascend to a predetermined obstacle avoidance elevation, navigate to the center of the structure, and descend to the predetermined elevation above the center of the structure.

15. The method of claim 12, wherein calibrating the difference between the takeoff elevation of the unmanned aircraft and the predetermined elevation above the center of the structure comprises the steps of:
controlling the unmanned aircraft to navigate according to a flight path of a predetermined flight plan for scanning a top of the structure;
determining a highest point of the structure based on data collected by the unmanned aircraft during the predetermined flight plan; and
determining a difference between the takeoff elevation of the unmanned aircraft and the highest point of the structure.

16. The method of claim 12, wherein the generated flight plan is based on one or more of a field of view of a camera attached to the unmanned aircraft, a pre-set aspect ratio of the camera, a height of the structure, or the footprint of the structure.

17. The method of claim 12, further comprising the step of controlling the unmanned aircraft along a flight path of the generated flight plan to:
ascend to a nadir view elevation;
capture at least one nadir view image of the structure;
capture overlapping images of a top of the structure;
capture at least one oblique view image of the structure;
navigate to a take off latitude and longitude; and
descend to an automatic landing elevation.

18. The method of claim 17, wherein capturing the at least one nadir view image of the structure comprises the steps of:
navigating to and capturing at first nadir view image of a first edge of the structure;
navigating to and capturing a second nadir view image of a middle of the structure; and
navigating to and capturing a third nadir view image of a second edge of the structure.

19. The method of claim 17, wherein capturing the overlapping images of the top of the structure comprises the steps of:
descending to a predetermined elevation; and
capturing the overlapping images of the top of the structure according to a predetermined flight path having a plurality of waypoints, each waypoint of the predetermined flight path corresponding to a different portion of the top of the structure.

20. The method of claim 17, wherein capturing the at least one oblique view image of the structure comprises the steps of:
determining an amount of oblique view images of the structure to be captured to provide coverage of the structure; and
controlling the unmanned aircraft to capture the determined amount of oblique view images of the structure by navigating the unmanned aircraft to oblique view capture waypoints corresponding to the determined amount of oblique view images.

21. The method of claim 12, further comprising the steps of:
determining the unmanned aircraft encounters an unexpected obstacle along a flight path of the generated flight plan; and
controlling the unmanned aircraft to evade the unexpected obstacle by modifying the generated flight plan and executing the modified flight plan.
